(19) United States
(12) Patent Application Publication
(10) Pub. No.: US 2018/0045977 A1
(43) Pub. Date: Feb. 15, 2018

(54) BRIDGELESS GLASSES

(71) Applicant: Daniil Safonov, Bila Tserkva (UA)

(72) Inventor: Daniil Safonov, Bila Tserkva (UA)

(21) Appl. No.: 15/555,505

(22) PCT Filed: Mar. 5, 2015
(86) PCT No.: PCT/IB2015/051612

§ 371 Date: Sep. 3, 2017

(51) Int. Cl. G02C 3/00; G02C 5/14

(52) U.S. Cl. CPC G02C 3/003; G02C 5/146

(57) ABSTRACT

A pair of bridgeless glasses fixed on the head by the pressure of its structure on the temples. Due to the absence of any connection between inner sides of lenses, there is no pressure to the nose. For the same reason lenses may undergo multiple manipulations, such as various kinds of regulation, movement and replacement. The glasses include: temporal connectors (1) with elastic fixing pads (2) that provide the tight fit to wearer's temples, rims (3) with lenses (4) or rimless lenses attached to said temporal connectors and the headband spring (5) which is connected to outer sides of both temporal connectors causing pressure for their fixation on temples. Headband spring can rely on the head or ears, causing additional fixation, or it may be absent in the case of using adhesives or suction cups to fix temporal connectors to temples.

### TECHNICAL FIELD

The present invention relates to glasses with the nonstandard head mounting scheme without a top bar and without a bridge.

### BACKGROUND ART

The most obvious way to disconnect glasses in area of the bridge and the top bar is use of a U-shaped headband which will be some sort of continuation for temples of glasses. Closest examples to such a structure are: KR 20100035415 (A) (SIM JONG SEOK) 2010-Apr.-5—GLASSES HAVING NO NOSE PAD and RU 2011126002 (A) (LANDO RON) 2014-Jan.-10—FOLDING GLASSES WITH SNAP BRIDGE. But despite of a similar design—both examples does not fully use all opportunities provided by the presence of the headband in the design of glasses.

Although in the first example (KR 20100035415 (A) (SIM JONG SEOK) 2010-Apr.-5—GLASSES HAVING NO NOSE PAD) the inventor almost got rid of the physical discomfort to the nose caused by nose pad, but bypassed other types of discomfort such as the effect of the magnet for eyes caused by the connection between inner sides of lenses and the pressure of the bridge to the nose. And even if you remove the bridge from these glasses—the load will fall on cheeks and it will entail another physical discomfort as well as another eye-magnet, but this time under eyes.

The following description discloses a method for the complete transfer of loads from the face to temples, which frees face from contact with units that causes discomfort and relieve the field of view from unnecessary overlying parts of common glasses. And also it opens additional opportunities offered by this design solution.

### DISCLOSURE OF INVENTION

The present invention is a non-standard eyewear. It is not a simple replacement of the joining between two halves of the glasses form the inner side of lenses to the outer side. It is the glasses with completely new type of wearing. The novelty lies in the complete absence of loads and pressure at frames and lenses and their transfer to the temples.

The basic design consists of nine parts: a pair of temporal connectors (1), a pair of fixing pads (2), a pair of rims (3) with a pair of lenses (4) and the headband spring (5). The whole idea is to use a spring features of headband spring (5). The compressive force of the headband spring (5) firmly presses temporal connectors (1) to temples. Fixing pads (2) made of elastic material distribute loads from temporal connectors (1) to the surface of temples, reduce the pressure and fix the placement of glasses. Thus lenses (4) connected with temporal connectors by rims are simply hanging in the air, without any contact with the nose, eyebrows, etc. The compressive force of the headband spring (5) also adjusts the structure of glasses for any size of the head. Despite the fact that headband spring (5) assumes the compressive function only, it's possible contact with ears and head can provide an additional fixing of glasses on the head.

Such a variation of glasses allows you to apply a large number of previously impossible modifications, both functional and aesthetic, which will be described further.

### BRIEF DESCRIPTION OF DRAWINGS

FIG. 1—The basic design with the marks

FIG. 2—An option without the headband spring

FIG. 3, FIG. 4, FIG. 5—Options for position of the headband spring

FIG. 6, FIG. 7, FIG. 8—Lenses movement—“Flip”

FIG. 9, FIG. 10—Lenses movement—“Slide”

FIG. 11, FIG. 12, FIG. 13—Lenses movement—“Parallax”

FIG. 14, FIG. 15, FIG. 16—Lenses movement—“Spin”

FIG. 17, FIG. 18, FIG. 19—The replacement of rims and lenses

### MODES FOR CARRYING OUT THE INVENTION

The present invention can be carried out in a variety ways. Following are variations of the headband attachment and additional features of lenses and rims.

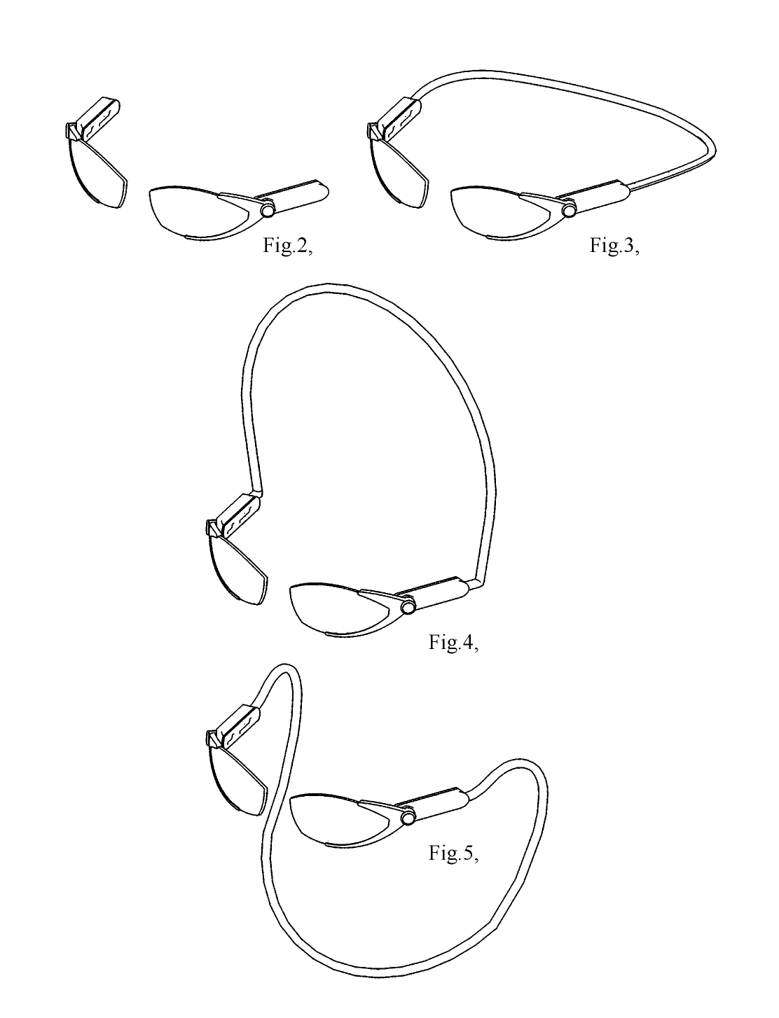

The first area of possible modifications for presented glasses is methods for their fixation to the head. There are four types of fixation: with the headband spring (5) at the back of the head, on the top of the head, under the chin and also without any headband spring (5). If the headband spring (5) goes through the back of the head (FIG. 3)—it creates a counterweight for lenses and further relies on the ears, thereby improves the fixation of the glasses on the head. In case the headband spring (5) goes on top of the head (FIG. 4)—the additional fixation falls on the head itself. If the headband spring (5) is held under the chin (FIG. 5), it must first go around ears for a horizontal fixation of the glasses. In considering these glasses as glasses with fixation at the temples—it is possible to exclude the headband spring (5) and use the direct fixation of temporal connectors (1) to the surface of temples (FIG. 2) by using adhesive or suction cups instead of fixing pads (2). If we talk about additional wearing options for the headband spring (5)—it can be used as a loop to be placed on the neck, when the glasses are not on the face.

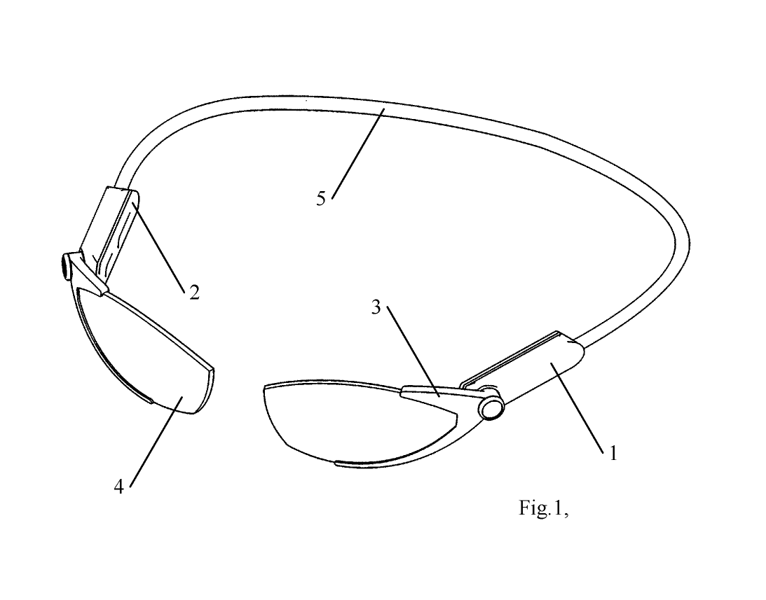

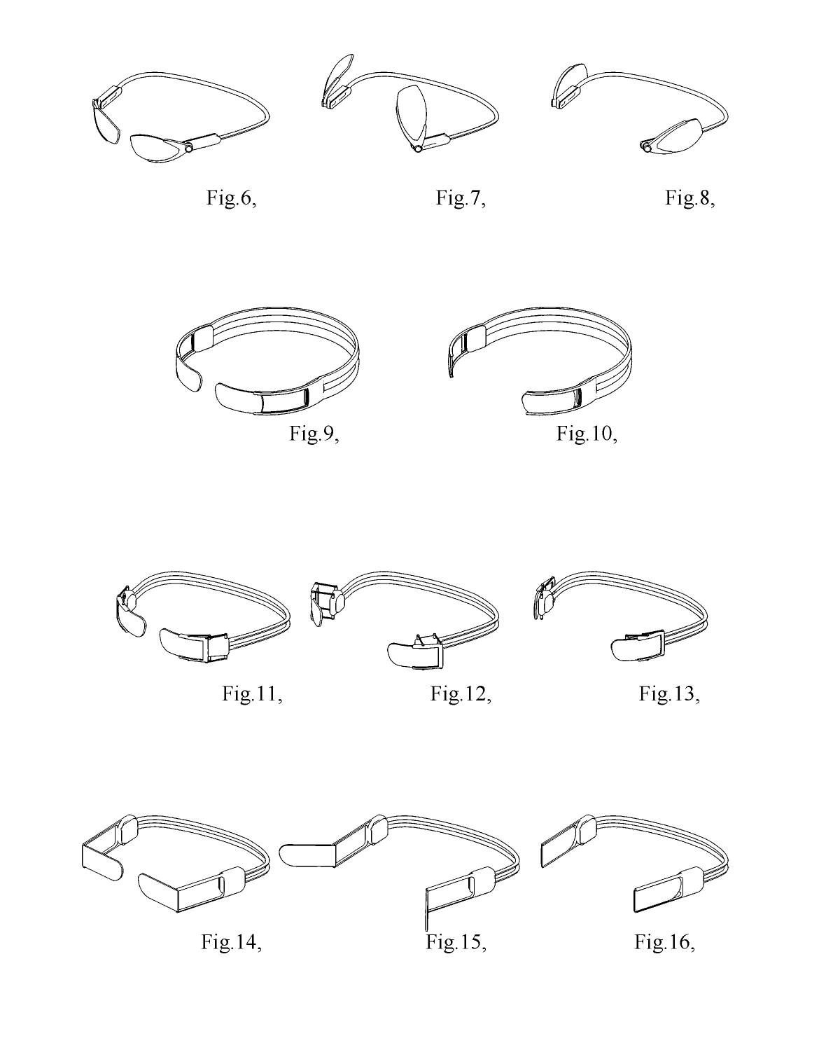

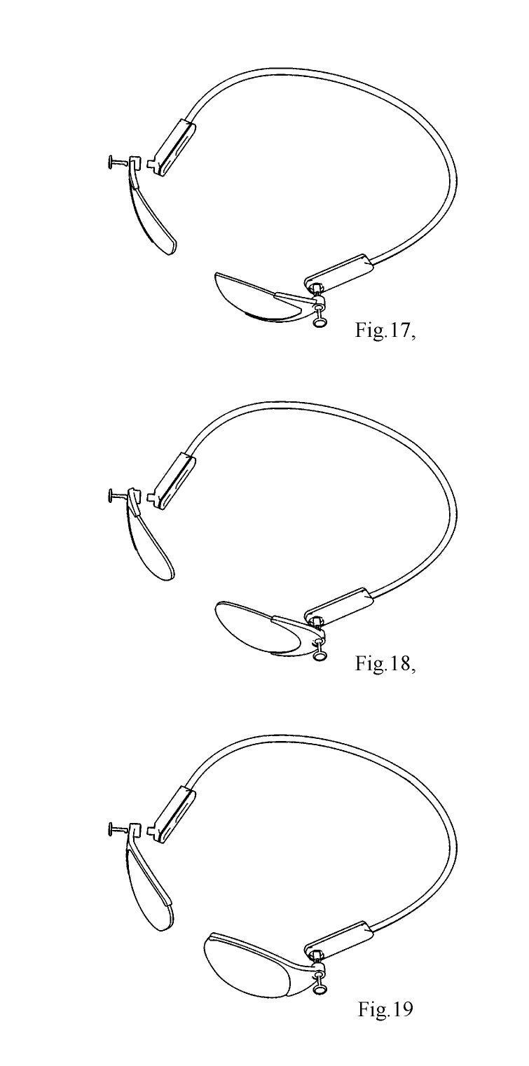

The second area of possible modifications for presented glasses consists in ways of manipulations with lenses and rims. As mentioned earlier—lenses and rims do not get any load and represent a console hanging in the air. This made it possible to give lenses the ability to move freely. This ability allows you to adjust (for wearing comfort) or completely hide (for a safety and exploitation purposes) one or both lenses without removing the glasses from the head. The following are four main types of lens movement: “Flip”, “Slide”, “Parallax”, “Spin”. The lenses movement “Flip” (FIG. 6, FIG. 7, FIG. 8) is the one that was presented in the basic design (FIG. 1). The basis for this movement is the rotation of rims and lenses parallel to temples. The lenses movement “Slide” (FIG. 9, FIG. 10) is represented by sliding of lenses along to guide frames in the direction from the nose to the temple and vice versa. The lenses movement “Parallax” (FIG. 11, FIG. 12, FIG. 13) is a non-parallel transfer of lenses from the plane parallel to eyes to the plane parallel to temples by two lever units. The last type of movement is “Spin” (FIG. 14, FIG. 15, FIG. 16). Its feature is the horizontal rotation through which lenses can be completely hidden in the body of glasses structure.

The third area of possible modifications for presented glasses is the simple replacement of rims with lenses (FIG. 17, FIG. 18, FIG. 19). By the fact that rims and lenses are closure parts in the structure of glasses, their fixing unit can be as simple as possible for disassembly. Thus it is a whole new concept for wearing of glasses in which it will be possible to replace not only lenses but one or both of rims for rims of completely different shape without affecting the basic body structure of the glasses.

Also the modification of such glasses implies the possible use of: complementing or replacing lenses with video screen; combination with a headphones, a microphone and a camcorder; attaching of additional fixing elements (such as earpieces and nose pads); increase of size to cover a larger face area; the use of additional optical electronic devices; the use of any materials for the structure of glasses that meet the functional requirements for the structure of glasses; the potential for implementation of the structure of glasses to tissues of the human head.

According to the inventor the base version (FIG. 1) of the bridgeless glasses includes most practical features of those listed above (vertically rotating lenses (FIG. 6, FIG. 7, FIG. 8) and the easiest way to connect them with the temporal connector (FIG. 17, FIG. 18, FIG. 19)) with a very simple and cheap manufacturing process. So it is chosen as the best mode for carrying out the invention.

### INDUSTRIAL APPLICABILITY

The present invention is the new type of glasses that creates alternative for such styles of glasses as: browline glasses, pince-nez, rimless glasses, etc. Therefore the appearance of such style of glasses makes it possible to create countless dozens of designs within boundaries of definitions of this concept. It can serve a useful role in the development of new fashion trends and uniquely will expand the assortment of related markets. And will also give an incentive for creativity to people who will be able to come up with additional modifications ideas for this new style of glasses.

1. The bridgeless glasses, comprising:
a pair of temporal connectors;
a pair of fixing pads connected to said temporal connectors in a place of their contact with temporal parts of the head;
a pair of rims with lenses units which on outer sides connected with the said temporal connector;
the U-shaped headband spring merged with said temporal connectors which pushes them to the temples by own spring tension thereby the said bridgeless glasses are kept on the head.

2. Any connections between inner sides of both said rims with lenses units must be excluded for the bridgeless glasses of claim 1.

3. The main function of the U-shaped headband spring of the bridgeless glasses of claim 1 is to create pressure on temples, but it also can provide additional support for said bridgeless glasses by the contact with the head and ears.

4. The U-shaped headband spring of the bridgeless glasses of claim 1 may not be included in the structure of said bridgeless glasses in case of using suction cups or adhesive for fixing said temporal connectors on the surface of temples.

5. Structure of the bridgeless glasses of claim 1 can be dismountable or solid.

6. The rim with the lens unit of the bridgeless glasses of claim 1 can be permanently fixed or able to rotate, turn, slide and shift relative to compound with the said temporal connector for regulation of the rim with the lens unit position.

7. Described movements of the rim with the lens unit of claim 7 can be automated by the return mechanism or the electronic mechanism.

8. The rim with the lens unit of the bridgeless glasses of claim 1 mustn't perform main supportive functions without which the said bridgeless glasses will not be able to hold on the head.

9. The rim with the lens unit of the bridgeless glasses of claim 1 has the capability to be replaced by another unit of different shapes or different functions.

10. The bridgeless glasses of claim 1 include the possibility of being supplemented with the video screen, the headphones, the microphone, the camcorder, optical electronic devices, additional fixing units of earpieces and nose pads.

11. The structure of the bridgeless glasses of claim 1 can be made of any suitable materials.

12. The temporal connector of the bridgeless glasses of claim 1 includes the possibility of being directly attached to the head by using implants for tissues of the head.
